(19) United States
(12) Patent Application Publication
(10) Pub. No.: US 2006/0147888 A1
(43) Pub. Date: Jul. 6, 2006

(54) Handheld tutorial device

(76) Inventors: Christopher Burghardt, Mount Laurel, NJ (US); Toshihide Hokari, Oak Ridge, NJ (US); Christopher Cappuccio, Maple Shade, NJ (US); Mark Todorovich, Medford Lakes, NJ (US)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/031,429

(22) Filed: Jan. 6, 2005

(51) Int. Cl. G09B 7/00

(52) U.S. Cl. 434/323

(57) ABSTRACT

An electronic handheld tutorial device having a display, an input element, a memory and a processor. The memory contains databases to enable a user to prepare for a test. The processor processes inputs from a user received from the input element and administers the test and provides a complete diagnostic analysis for the results of the test on the display.

### FIELD OF THE INVENTION

This invention relates to a handheld tutorial device that can be used as a testing tutorial and reference guide. More particularly, the invention relates to a handheld device that provides a complete diagnostic analysis based on the outcome of a practice test to a user in a quick and efficient manner.

### BACKGROUND OF THE INVENTION

In today's world, test tutorial services and testing study guides have become a lucrative industry. Students attending junior high to graduate schools rely heavily on tutorial courses and guides. One particular test, the Scholastic Aptitude Test (SAT) is a crucial benchmark for all high school students considering attending universities. As a result, numerous tutorial services have marketed guide books, online courses, and in-class courses to fill this need.

These testing tutorial services are generally provided by testing companies such as Stanley Kaplan and others. A student may subscribe to any one of a plurality of such testing institutions. However, the student is typically restricted by the design of these testing methods. For instance, the student is required to either attend a tutorial service, or sit at a computer and complete an online tutorial session. Also, present testing materials are generally very expensive and time consuming.

Therefore, there is a need for a handheld portable device that is economical and which provides a student or individual the ability to access the testing materials and evaluate the tested materials in an efficient and quick method. Also, since students are typically “on the go”, there is a need for a device that would provide portability and accessibility to testing materials.

### SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with one aspect of the present invention, there is provided an electronic handheld tutorial device having a display, an input element, a memory and a processor. The memory contains databases to enable a user to prepare for a test. The processor processes inputs received from a user from the input element and provides a complete diagnostic analysis of an outcome of the test on the display.

In accordance with another aspect of the present invention, there is provided a tutorial device, comprising: a handheld housing, a display, a user input device and a processor located within said housing. The display is capable of showing questions for a practice test. The user input device is capable of accepting answers to questions of a practice test from a user. The processor is capable of operating a computer program that will administer said practice test to the user, analyze said answers to the questions of the practice test and diagnose the answers to enable the user to focus on areas of the practice test in preparing for the actual test.

In accordance with the present invention, there is provided a handheld tutorial device with a database stored in a memory, the database containing a test. A display is provided for displaying the test for a user to perform. An input element is also provided for a user to select inputs based on the test. A complete diagnostic analysis is based on the time and the answer selection with respect to the testing materials.

In accordance with the present invention, there is provided a method of storing and processing tutorial data in a handheld device comprising the steps of storing data in a memory, the data being test tutorial materials, displaying the test tutorial materials on a display device, and inputting selected answers to an input element. The method also includes the step of generating a complete diagnostic analysis of inputted selected answers with respect to the test tutorial materials.

### BRIEF DESCRIPTION OF THE DRAWINGS

The foregoing and other advantages of the invention will become apparent upon reading the following detailed description and upon reference to the drawings in which:

FIG. 1 illustrates a general schematic of a handheld device that implements one embodiment of the present invention.

FIG. 2 shows the front view of an apparatus that implements one embodiment of the present invention.

FIG. 3 shows a Home Menu utilized in one embodiment of the present invention

FIG. 4 shows a menu when the SAT PREP option is selected from the Home Menu in one embodiment of the present invention.

FIG. 5 shows text of one page from the SAT prep manual according to one embodiment of the present invention.

FIG. 6 shows a math drill from the SAT prep manual according to one embodiment of the present invention.

FIG. 7 illustrates a menu in one embodiment of the present invention when the SAT/ACT practice test option is selected from the Home Menu.

FIG. 8 shows a bookmarking menu according to one embodiment of the present invention.

FIG. 9 illustrates a Test Reports menu in one embodiment of the present invention.

FIG. 10 illustrates a menu of a specific SAT test report in one embodiment of the present invention.

FIG. 11 shows a diagnostic report of a question by question analysis of the practice test in one embodiment of the present invention.

FIG. 12 shows a diagnostic analysis of a specific question from a particular practice test, with hypertext to allow the user to navigate to another menu, in one embodiment of the present invention.

FIG. 13 illustrates the menu in one embodiment of the present invention when the reference option is selected in the Home Menu.

### DETAILED DESCRIPTION OF THE INVENTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such development effort might be complex and time-consuming, but would nevertheless be a routine undertaking of design, fabrication and manufacture for those of ordinary skill having the benefit of this disclosure.

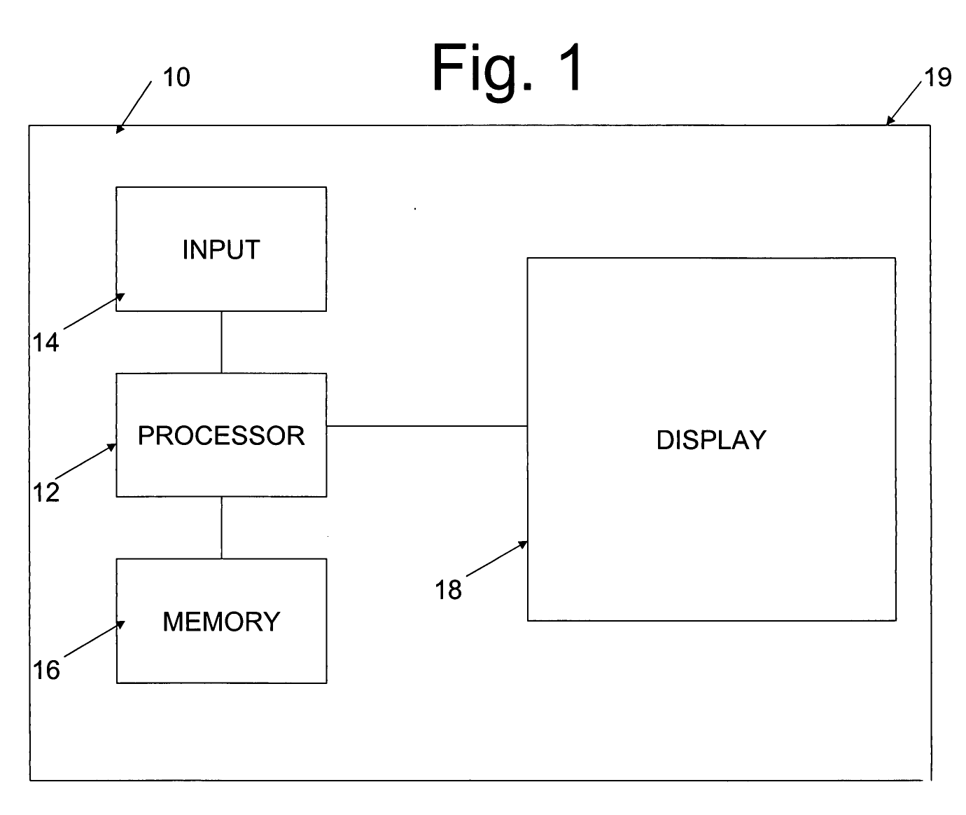

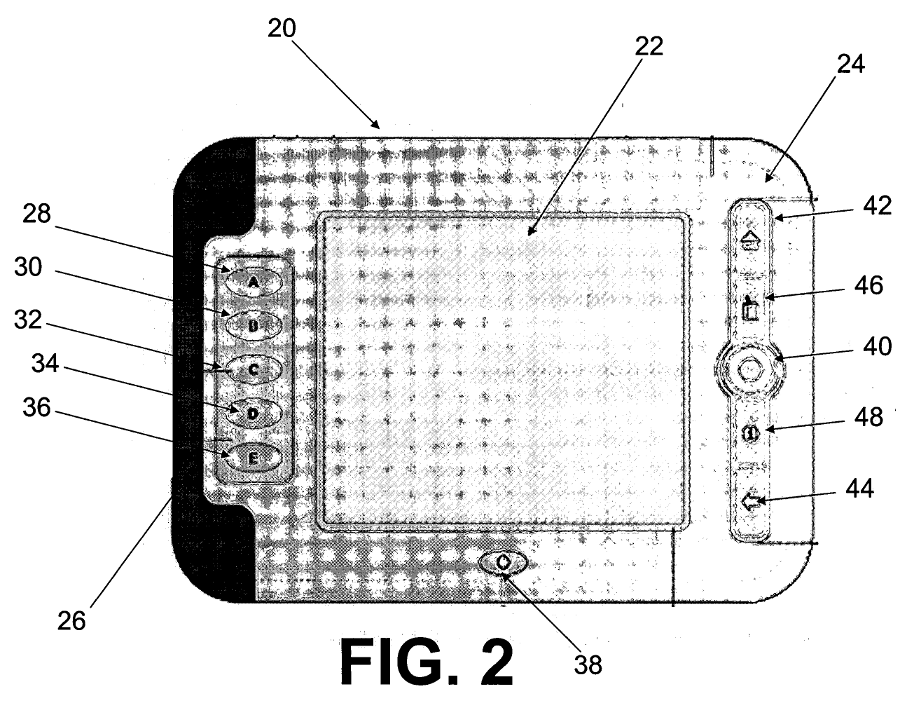

Turning now to the drawings, and referring initially to FIG. 1, a block schematic of elements incorporated in one exemplary embodiment of the present invention is illustrated and designated by the reference numeral 10. Device 10 includes a processor 12 that is connected to input element 14 and a memory element 16. A display element 18 is also connected to the processor 12. The processor 12, input element 14, memory element 16 and the display element 18 are provided in a housing 19 that will be described in greater detail in reference to FIG. 2. The processor 12 controls the operation of input 14, display 18 and memory 16.

The display 18 controls the screen used to provide information back to the user. Other circuits that would work in conjunction with display 18 to convey information back to the user, such as a sound unit, can be added to the device without changing the teachings of this invention. Input 14 is electrically connected to a main processor unit. Data entered into the input 18 from the user is received and conveyed to the processor 12. The display 18 and the input 14 can be combined if a touch screen were implemented. Processor 12 is also electrically connected to memory 16. The memory unit acts as the main storage area for data, including the main database. The memory 16 can be comprised of memory chips that are permanently located within the apparatus. It can also include an external memory unit that is temporarily connected to the device.

It should be noted that additional elements may be incorporated within the housing of device 10 to provide greater flexibility and portability. The present invention is provided in a highly portable and flexible housing which is suitably fitted to provide a user with easy access to the input element. The present invention also provides the user with a display screen that is easy to view text on and a memory that is able to hold and store sufficient data for the user. There may also be provided serial ports (Not Shown) on the portable device that allows connections to external devices.

FIG. 2 depicts a more detailed layout of a handheld tutorial device 20 of the present invention. The handheld tutorial device 20 has a display screen 22 directly in the center of the device. The display screen 22 in this embodiment is provided with an active viewing area of 75 mm×63 mm. Navigation keypad 24 and an answer selection keypad 26 are located on the right and left hand sides of the device respectively. There is also a power on/off button 38 which is provided centrally in the bottom portion of the portable device 20. The positioning of the navigation keypad 24 and the answer selection keypad 26 provide a user friendly layout. A user can hold the device with both hands and still access both the navigational keypad and answer keypad with their thumbs. As a result, the user is provided with a display screen and keypad that is user-friendly and compact.

Answer selection keypad 26 is provided with answer keys A-E (28-36). These keys are primarily used by the user when taking a test in order to enter a choice to a question or make a menu selection. The navigation keypad 24 has an arrangement of keys that allows the user to input data and enables the selection of options provided by software of the handheld tutorial device 20. The navigation keypad 24 has an up, down, left/previous, right/next, and enter/select keys 40. There is also a home key 42, which enables the user to go to a home menu which is described in greater detail below. The back key 44 enables the user to go back to the previous page/state. There is also on the keypad 24 a mark key 46 which allows the user to access the bookmarks menu or mark/unmarks selected data. A help key 48 is also provided which provides the user context-sensitive help and test question instructions. As a result of the keys from the navigation keypad 24 and the answer selection keypad 26, the device provides an efficient portable complete system for undertaking a tutorial course.

In the present invention, a total of fifteen keys are provided. In one embodiment of the present invention, the display screen is a LCD screen, but it can be any screen suitable to displaying graphics and/or text to the user. It should be noted that the present invention is adaptable to receive speech activated commands, a touch screen, and other similar devices. As mentioned above, the layout of the features of the present invention enables the user to utilize a user-friendly portable electronic tutorial device.

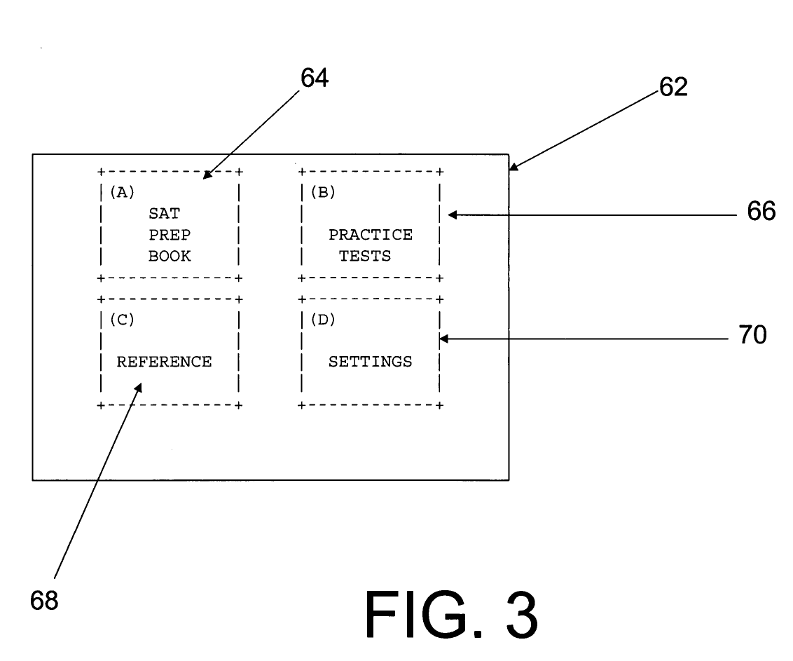

FIG. 3 shows an illustration of a menu provided on the display screen providing options based upon the software in the present invention. More specifically, FIG. 3 illustrates the Home Menu 62 in one embodiment of the present invention. In the Home Menu 62, four options are provided: (1) a SAT prep option 64, (2) a practice test option 66, (3) a reference option 68, and (4) settings options 70. Each option is also marked with a corresponding answer key (A-D) so that a selection can be made using the answer selection keypad 26. The user can also navigate this menu using the navigational keypad 24. The SAT PREP option 64 is the default choice on the screen and, as a result, the SAT prep option 64 is highlighted.

Selecting the SAT prep option 64 provides the user with general information and strategies for taking the SAT. More specifically, testing materials are provided in a SAT preparation manual that have information on how to obtain a better score. For instance, the testing manual book provides hints, suggestions and drills pertaining to each section of the test. The SAT preparation manual will be discussed in greater detail below.

The practice test option 66 provides the user with the ability to commence a practice test. In the present embodiment, three practice SAT tests are provided. The practice tests are timed and test reports are generated which provide a complete diagnostic analysis for each completed test. The diagnostic features of the test reports will be discussed in greater detail below.

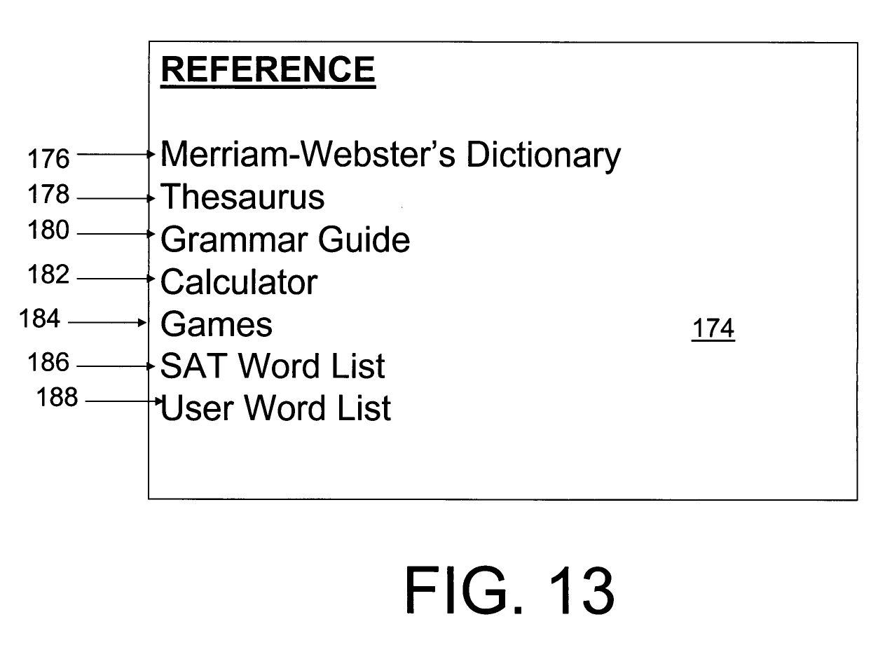

A reference guide 68 option is also provided. The reference guide includes many different features so that a user may have a complete reference guide in a portable and flexible setting. For instance, a dictionary, thesaurus, word list, and calculator are provided. The reference guide will be discussed further in reference to FIG. 13.

A fourth option is the settings 70 option which enables the user to change the settings to there preferences, such as the time, date, and screen lighting. The settings option provides the user the ability to efficiently personalize features in the handheld tutorial device.

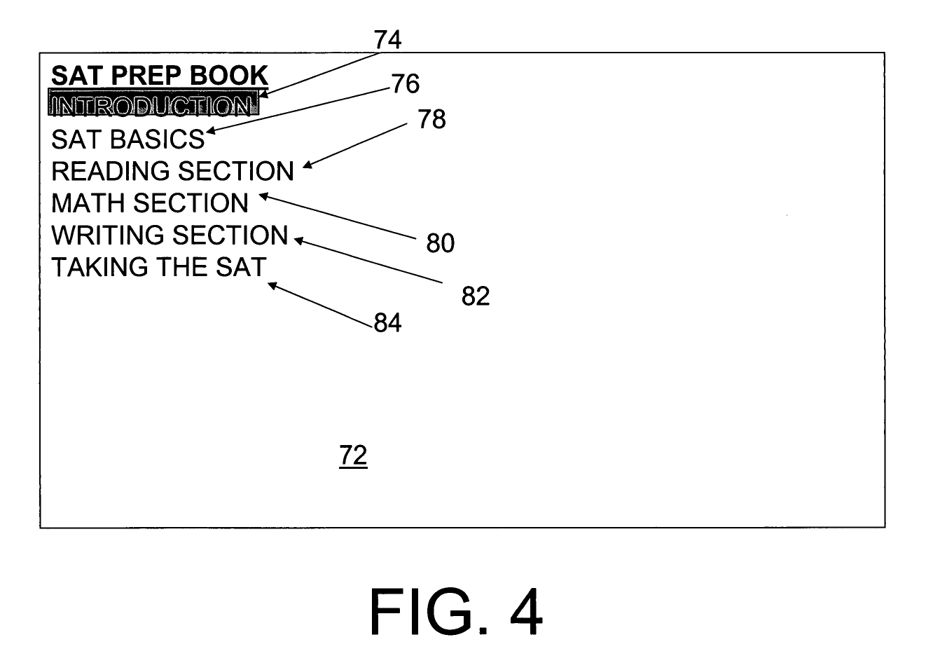

FIG. 4 illustrates the menu when the option for SAT PREP 64 is selected. The menu 72 shows additional options for an individual to select. Specifically, FIG. 4 shows an Introduction option 74, SAT BASICS option 76, READING SECTION option 78, MATH SECTION option 80, WRITING SECTION option 82, and TAKING THE SAT option 84 are provided. The user will select the option desired by using the navigational keypad 24.

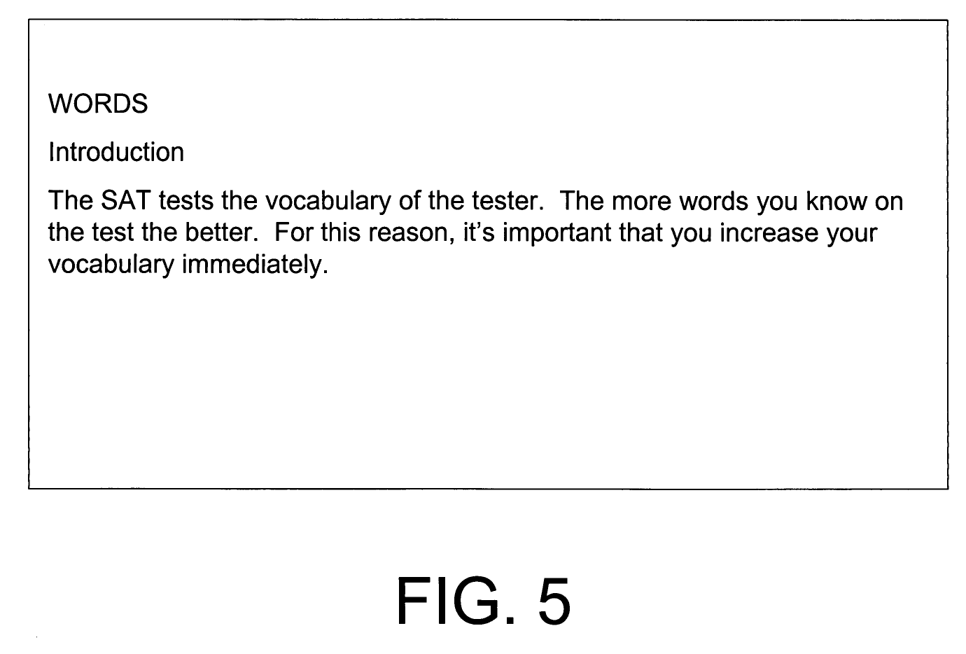

The SAT preparation manual 64 is arranged in a section by section reference of the SAT. For instance, in the READING SECTION option, hints and suggestions in generating a better score are provided in regard to the reading section of the SAT. Similarly, suggestions and hints on how to obtain better math and essay scores are provided in the MATH SECTION option and the WRITING SECTION option. There is also provided general information and suggestions on taking the SAT in the TAKING THE SAT option. FIG. 5 shows a typical text section.

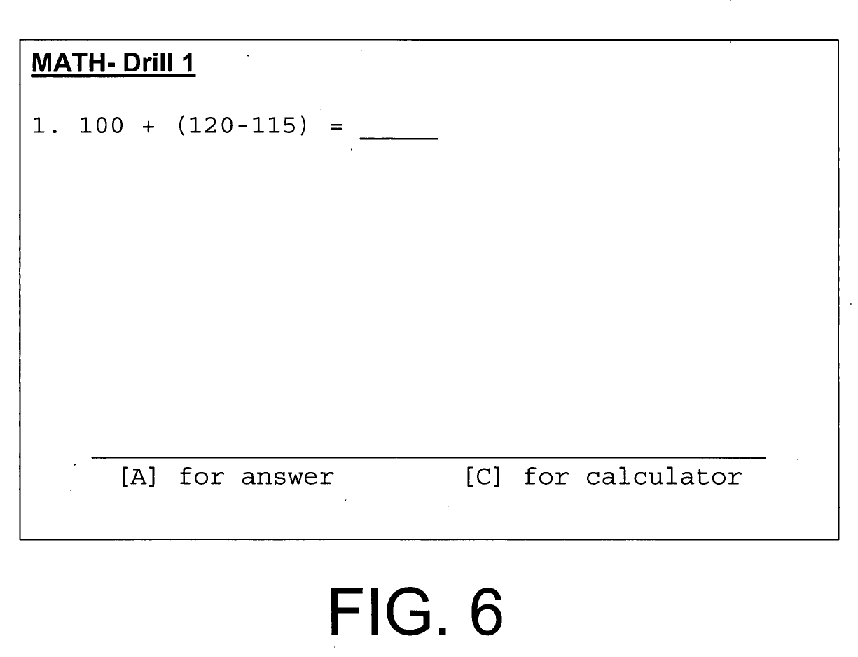

In addition to these text sections, the SAT preparation manual provides drills on each section of the test. FIG. 6 shows a typical drill that a user can answer. Thus, the user may choose to answer questions in a drill section particularized to each section instead of undertaking a full timed SAT practice test. These drills may be timed or un-timed. More specifically, there are drills provided such as reading section drills, sentence completion drills, and math skill drills. Each section drill tests the user in that specific area of the SAT.

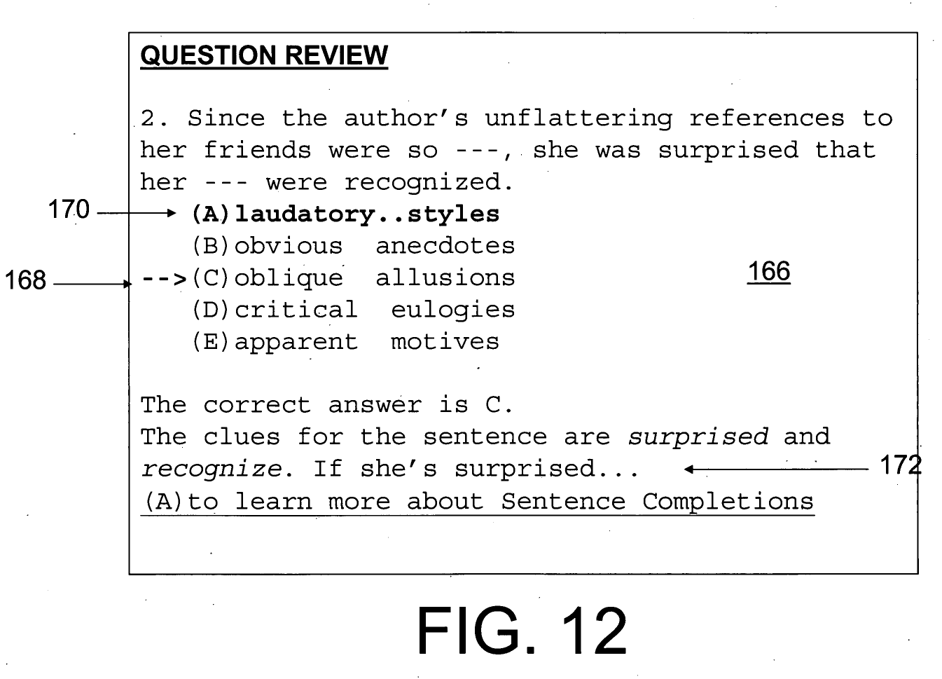

As mentioned above, when a user is in a portion of the applications program that is not the timed SAT practice test, the user has the ability to navigate through the software provided in the handheld tutorial device through the use of hypertext links. For instance, when the user is practicing a sentence completion question, there is provided a hypertext link to the section of SAT preparation book that the user may navigate to review the subject and gain hints specific to that question as shown in FIG. 12. It should be noted that the SAT preparation menu is adapted with hypertext links to different parts of the manual also, so that the user can navigate through the different sections of the manual using the hypertext links. Thus, the user can navigate between reference guides, help texts and drill sections by selecting different links provided in the SAT preparation manual. This allows the user to move directly to sections on which he wants to focus in order to more efficiently prepare for the different sections of the test. Instead of having to fumble through many different manuals, all of these materials are available to the user in one compact device.

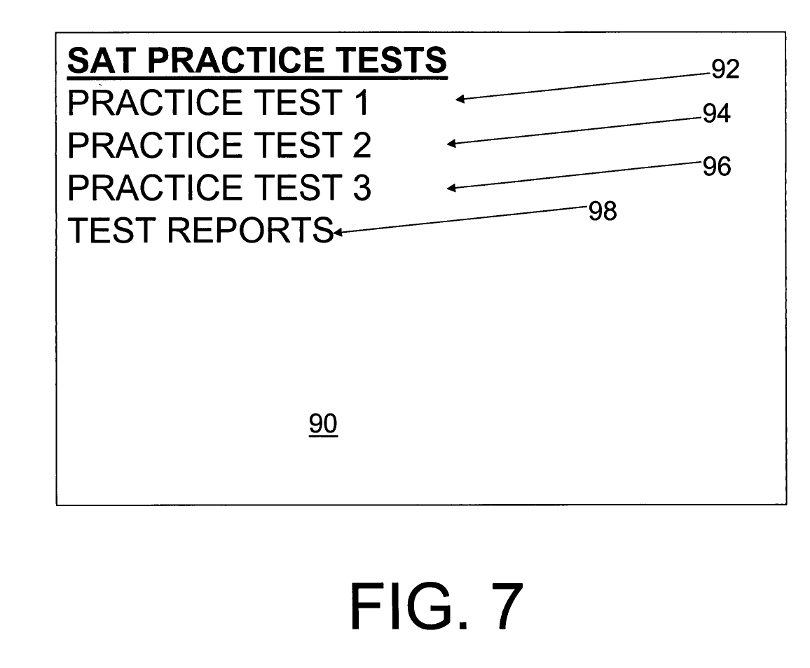

FIG. 7 illustrates the menu 90 when the practice test option 66 is selected from the Home Menu 62. As mentioned above, three practice test options 92-96 are provided in this embodiment. As a result, the user is provided the flexibility to take different tests at different times. A test reports option 98 is also provided in the menu 90. Each practice test is organized by test sections and within each section are question sets. Each question set contains an instruction set, which provides detailed instructions for the test questions that follow. For certain question types, the instructions are followed by reference information. For example, in math sections, instructions on how to answer and complete math questions are followed by reference information that includes the formulae for the area and circumference of a circle and the area of a triangle. Test questions begin after the reference information (if any) is displayed. Therefore, the user is provided an accurate overview of the materials provided during the actual SAT.

The tests are organized into math sections, reading sections, grammar sections and an essay section. Each test question has a hypertext link to the instructions for its question set and to the reference information supplied for that question, if any exists. In more detail, the display depicts a question and answer when in the practice test option. The user selects from choices A through E to answer the question provided. Once an answer is selected, the next question is shown. As the test progresses, the running time is displayed on the screen. The test can be stopped so that the user has more flexibility on when to take the test. Thus, a user may pause the test whenever and begin the test at the user's convenience. When the user pauses the test, the question is removed from the display and the timer is stopped and the time stored. When the user restarts the test again, the timer is restarted from the time it was stopped. The user is able to continue without restarting the test from the beginning and the time recorded for taking the exam is maintained.

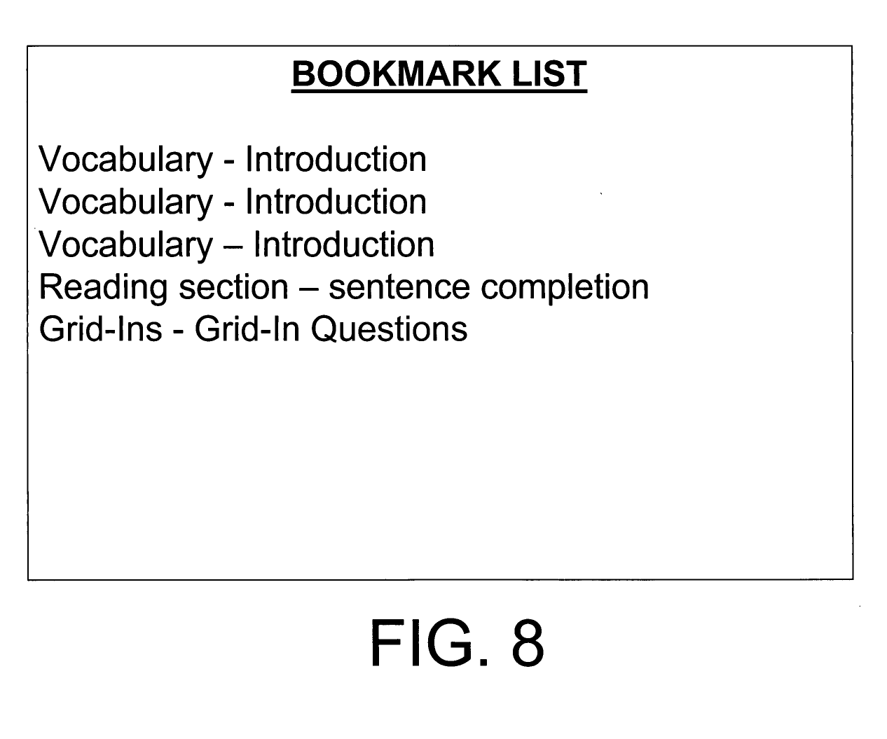

Another feature provided by the application software is bookmarking. Bookmarking allows the user to mark areas of the SAT preparation manual and test reports for later analysis. FIG. 8 shows a bookmarking menu that allows the user to navigate through the bookmarked list to return to the specific bookmarked item. During tests, questions from different sections can be marked so that the user can later review a specific question. The user can review a difficult question or return to the SAT Preparation manual to review/study the section on that specific material. Marked questions have a check mark to the left of the first line of the question. The bookmarking menu provides the user a short list so that problem questions and areas may be “remembered” for further review and analysis.

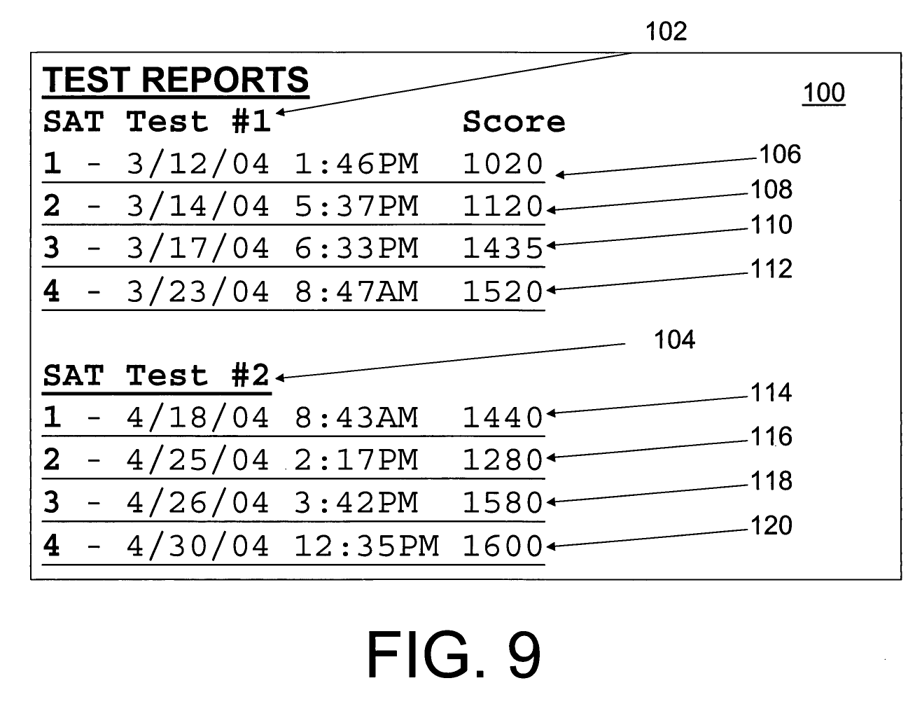

FIG. 9 illustrates the menu 100 when Test Reports 98 is selected from the Practice Test menu 66. The Test Reports menu 100 chronologically lists the tests taken along with the time and scores for each particular test. The user can then go to a specific test and review the selected test. The menu 100 shows the test report options for SAT test #1 102 and SAT test #2 104. The menu 100 also shows that the SAT test #1 has been selected and completed four times 106-112. The menu 100 provides the date, time and score for each of the completed tests. The menu 100 also shows that the SAT test #2 104 has been taken four times 114-120. The date, time and score for tests 114-120 are also illustrated. Thus, the user can take the same practice test as many times as desired based on the available memory. It should be further noted that additional SAT tests can be stored in the handheld device memory. The user can review each practice test by scrolling down through the practice tests using the navigation keypad 24.

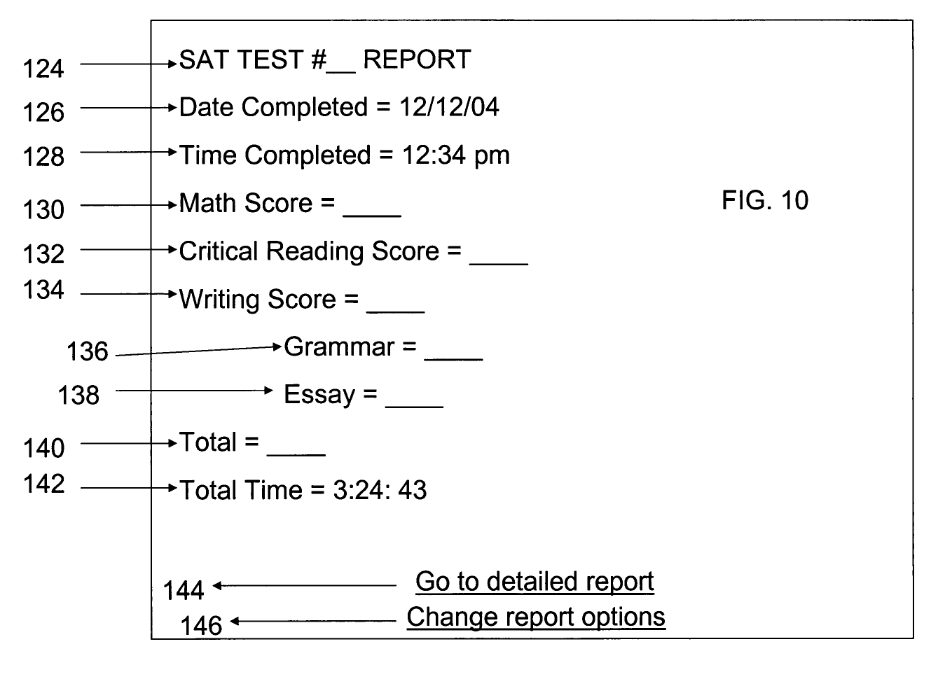

FIG. 10 illustrates a test report analysis menu 122 for each particular test. The specific SAT test report 124 provides the date completed 126, time completed 128, the math score 130, critical reading score 132, writing score 134 including the grammar 136 and essay 138, total score 140 and the total time 142 for each practice test taken. There is also provided the option to obtain a more detailed report 144 and to change report option 146. The menu can be navigated by scrolling between highlighted items using the navigational keypad 24.

The present invention also enables the user to review each particular test broken down by different categories. A user may review the questions by section and test sequence. As a result, a user who has trouble in a specific section can review a test report based on the specific section versus the other sections. Thus, the application software provided in the present invention enables the user to specify and personalize the diagnostic analysis report to focus on the areas that he wishes.

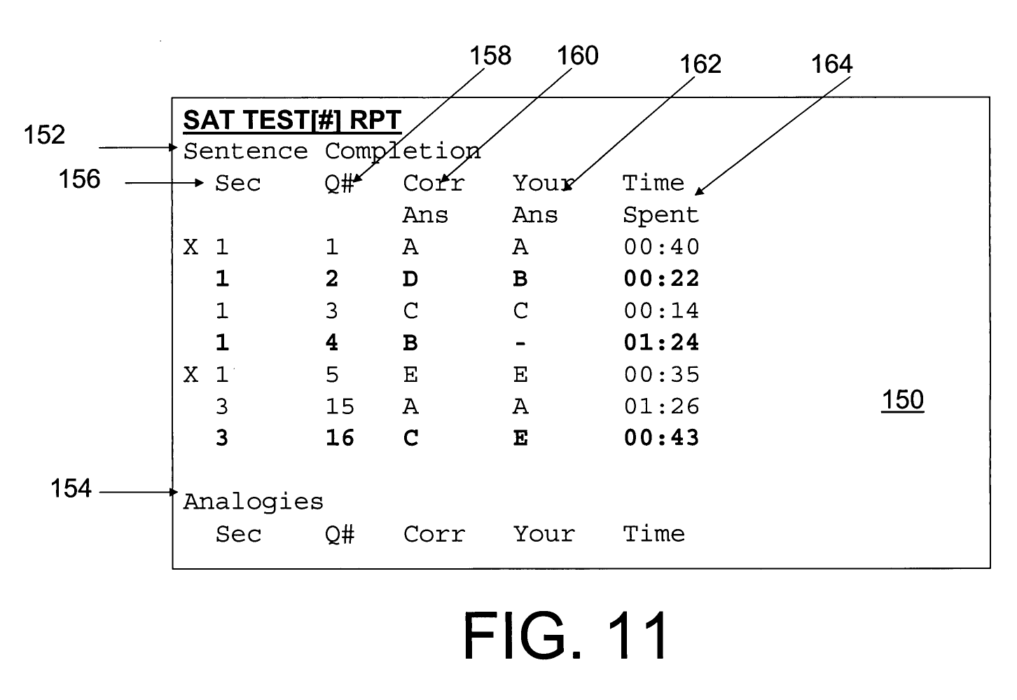

In addition, the Test Reports feature also enables the user to review a complete test by analyzing all answers including incorrect, correct, and unanswered questions. The test reports feature also enables the user to review the test by the percentages of the correct answers, incorrect answers and unanswered questions for specific question types. Thus, the present invention provides a complete diagnostic analysis of each practice test that is taken in a flexible and portable device. These features will be discussed in further detail in reference to FIG. 11 and FIG. 12.

FIG. 11 illustrates a more specific analysis provided by the present invention. Specifically, the present invention provides a question by question analysis menu 150 for each particular practice test. In this menu, each test is first organized by section, Sentence Completion 156 and Analogies 154. Within each section, particular questions from the test are listed in each section. For instance, as illustrated in FIG. 11, questions 1, 2, 3, 4, 5, 15 and 16 are listed under the Sentence Completion section. The test report provides data for each of these questions including the Correct Answer 160, the user's answer 162 and the time spent on each question 164. Unlike other timed tests which only report on the total time spent, the time is further broken down by each question. This will allow the user to understand which type of questions take more time than other type questions.

The entire report is displayed and scrollable. The user can navigate through the report using the navigation keypad 24 and is provided a hypertext link to each specific question. The user can return to the question and be able to review the question. FIG. 12 shows a screen with a question from the reading section of the SAT as provided in the test report menu 166 according to the present invention. In this instance, the correct answer is marked 168 and the user's answer is highlighted 170. In addition, explanation text 172 is provided so that the user may better understand the question and answer. A hypertext link to the relevant section of the SAT preparation manual is also provided, in case the user wants to review/study this type of question.

It should be noted that the present invention also provides further analysis of each practice test by allowing the user to review the percentage of correct answers and incorrect answers for each question type and/or section. The handheld device can also provide percentages of unanswered questions for each section and/or question type. Since the present invention is a handheld device, the user has the flexibility to complete tests and receive a complete diagnostic analysis for each test at a pace chosen by the user.

FIG. 13 illustrates the reference menu 174 as selected from the Home Menu 62. The reference menu 174 provides a Merriam-Webster's Dictionary 176, a thesaurus 178, a grammar guide 180, a calculator 182, games 184; a SAT word list 186 and a User word list 188. The user may scroll through these options using the navigation key pad 24 and select the preferred option.

The Merriam-Webster's Dictionary 176 is an English-language dictionary. The application software provided in the present invention will allow the user to look up the definition of a word by using the navigation keypad 24. Upon selecting the word using the navigation keypad 24 and pressing the enter key, the device will display the definition of the word.

A thesaurus is also provided so that the user can look up words that are similar to the one selected. The grammar guide 180 provides the user the ability to review parts of speech, spelling, punctuation, the sentence, style and usage. The information provided by the grammar guide 180 is also provided in the SAT preparation manual.

Games which are directed to the preparation of the SAT are also provided in the present invention. A games menu provides the user with a flash cards option, letris, word dozer, SAT drills, and grammar quizzes. The flash card option provides the user with words and their definitions based on a SAT word list and a User word list.

The application software of the present invention may provide additional features to enable the user to study for a test at the user's pace with greater ease and flexibility. The discussed electronic handheld tutorial device provides the user complete tutorial materials and a complete diagnostic analysis in a portable and flexible environment.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

We claim:

1. An electronic handheld tutorial device comprising:
a processor;
a display electrically connected to the processor;
an input element electrically connected to the processor;
a memory containing at least one database; said at least one database comprising a practice test; and
wherein said processor allows a user to practice for a test by accessing said at least one database on said memory, displaying said practice test on said display; processing inputs received from a user from the input element in response to questions in said practice test; and providing a complete diagnostic analysis of said responses to the question in said practice test.

2. The electronic handheld tutorial device according to claim 1, wherein said database further comprises a SAT preparatory book.

3. The electronic handheld tutorial device according to claim 1, wherein said database further comprises a reference guide.

4. The electronic handheld tutorial device according to claim 1, wherein the processor processes a timing function while the user is practicing on said practice test.

5. The electronic handheld tutorial device according to claim 1, wherein the processor processes an auto score save function so that each test is saved.

6. The electronic handheld tutorial device according to claim 1, wherein the processor processes context-sensitive help function.

7. The electronic handheld tutorial device according to claim 1, wherein the input element comprises an answer selection keypad.

8. The electronic handheld tutorial device according to claim 1, wherein the input element comprises a navigation keypad.

9. The electronic handheld tutorial device according to claim 4, wherein the complete diagnostic analysis provides data on the amount of time that the user spent on each question.

10. The electronic handheld tutorial device according to claim 4, wherein the complete diagnostic analysis distinguishes time based on different types of questions.

11. The electronic handheld tutorial device according to claim 1, wherein the processor provides a hypertext function to allow the user to navigate within said database.

12. The electronic handheld tutorial device according to claim 1, wherein the processor allows a bookmarking function to allow the user to indicate where to revisit within said database.

13. The electronic handheld tutorial device according to claim 4, wherein the processor processes the timing function only when said user is responding to said questions of said practice test.

14. A tutorial device, comprising:
a handheld housing;
a display located within said housing; said display capable of showing questions for a practice test;
a user input device located on said housing; said user input device capable of accepting answers to questions of a practice test from a user;
a processor located within said housing; said processor capable of operating a computer program that will administer said practice test to the user, analyze said answers to the question of the practice test and diagnose the answers to enable the user to focus on areas of the practice test in preparing for the test.

15. The handheld device according to claim 14, wherein the computer program will diagnose the answers by calculating the amount of time that the user has spent when answering each question of the practice test.

16. The handheld device according to claim 14, wherein the computer program will diagnose each question separately.

17. The handheld device according to claim 14, wherein the computer program will diagnose each question categorized on the type of question or test sequence.

18. A method of storing and processing tutorial data in a handheld device comprising the steps of:
storing data in a memory, the data being test tutorial materials;
displaying the test tutorial materials on a display device;
inputting selected answers to an input element; and
generating a complete diagnostic analysis of inputted selected answers with respect to the test tutorial materials.

19. The method according to claim 18, wherein the step of generating further comprises generating a question by question diagnostic analysis.

20. The method according to claim 18, wherein the step of storing further comprises storing a SAT preparatory book.
